(19) United States
(12) Patent Application Publication
(10) Pub. No.: US 2008/0161106 A1
(43) Pub. Date: Jul. 3, 2008

(54) METHOD OF AND APPARATUS FOR SOLVING SUDOKU PUZZLES

(76) Inventor: Alvan M. MORRIS, Chevy Chase, MD (US)

Correspondence Address: LOWE HAUPTMAN HAM & BERNER, LLP, 1700 DIAGONAL ROAD, SUITE 300, ALEXANDRIA, VA, 22314, US

(21) Appl. No.: 11/618,389

(22) Filed: Dec. 29, 2006

(51) Int. Cl. A63F 13/00

(52) U.S. Cl. 463/31

(57) ABSTRACT

A display, either on a sheet or an electronic device, for use in solving a Sudoku puzzle includes a 9×9 matrix of cells arranged in nine columns and nine rows. Each cell includes nine different characters representing trial solution numerals from one to nine inclusive. A user selectively causes deletion of trial solution numerals from the cells. An electronic device including the display has (1) a data reader for reading instructions for initial numerals of selected columns and rows from a memory medium a user selectively inserts into and removes from a receptacle of a housing carrying the electronic device, and (2) keys for entering initial numerals from another Sudoku puzzle source into the cells.

### FIELD OF THE INVENTION

The present invention relates generally to a method of and apparatus for solving Sudoku puzzles.

### BACKGROUND ART

Sudoku, also known as Number Place or Nanpure, is a logic-based number placement puzzle. The object of the puzzle is to enter a numerical digit from one through nine in each cell of a 9×9 matrix of nine rows and nine columns, that form nine 3×3 sub-matrices. Initially, characters representing various numerals (initial numerals) are entered in some of the cells. The person attempting to solve the puzzle, that is, a user, must determine solution numerals for the remaining cells so that each row, column and sub-matrix contains only one instance of each of the solution numerals one through nine so there is no duplication of a solution numeral within each row, column or sub-matrix.

The puzzles have usually been included on a tangible physical medium, such as a sheet of paper of a newspaper or book. In such an instance, a typical user attempting to solve the puzzle inserts plural trial solution numerals into the remaining cells and then uses logic to determine which of the inserted trial solution numerals are to be removed. Inserting the trial solution numerals can be arduous and cumbersome due to the limited area of each cell. Removal is typically by crossing out one or more of the trial solution inserted numerals. If an incorrect trial solution numeral is removed from a particular cell, restoring a cell to a usable condition is difficult and in some instances virtually impossible.

The puzzles have also been presented to users on a display of an electronic device, such as a personal computer screen, or a liquid crystal display of a handheld, battery operated electronic device including a processor and an internal read-only memory storing several puzzles and the solutions thereof. Manually inserting trial solution numerals on the displays of the electronic devices is not usually feasible. At least some of the handheld, battery operated electronic devices immediately enable the user to determine if the solution numeral entered into a particular cell is correct or incorrect. Consequently, the challenges presented to the user of such hand-held battery-operated electronic devices are considerably less than those associated with solving the puzzle on a sheet of paper. The Internet has been used to supply Sudoku puzzles containing the initial numerals of the cells to the display screen of a personal computer having a mouse or other cursor position control device for enabling a user to use a keyboard to insert solution numerals into the remaining cells.

It is, accordingly, an object of the present invention to provide a new and improved method of and apparatus for solving Sudoku puzzles in a manner that provides greater enjoyment to a user of the puzzle.

Another object of the invention is to provide a new and improved method of and apparatus for solving Sudoku puzzles with the aid of an electronic device, while maintaining the level of logic required by a user in solving the puzzle.

An additional object of the invention is to provide a new and improved method of and apparatus for solving Sudoku puzzles with the aid of an electronic device, wherein a user of the device can enter puzzles into the device based on sources external to the device, such as a newspaper or book.

A further object of the invention is to provide a new and improved method of and apparatus for solving Sudoku puzzles with the aid of an electronic device, wherein a user of the device can enter puzzles into the device from an external memory device that the user can easily selectively insert into and remove from a housing of the device.

### SUMMARY OF THE INVENTION

In accordance with one aspect of the invention, a display for use in solving a Sudoku puzzle comprises a tangible medium, such as a sheet of paper or a computer display, including a 9×9 matrix of cells arranged in nine columns and nine rows, wherein at least some of the cells include nine different characters representing trial solution numerals from one to nine inclusive.

Preferably, each of the cells includes nine different characters representing the trial solution numerals from one to nine inclusive.

In one embodiment, the tangible medium includes a first sheet, such as a sheet of paper, having characters representing the nine trial solution numerals in each cell. Preferably, the first sheet is stacked with a second sheet having a second 9×9 matrix of cells arranged in registration with the cells of the first sheet. The cells of the second sheet are adapted to have characters representing initial numerals from one to nine inclusive inserted thereon in response to a user entering initial numerals on the first sheet and/or solving the puzzle.

In another embodiment, an electronic device is in combination with a display that is the tangible medium. The electronic device is arranged for writing the characters representing the nine different trial solution numerals into at least some of the cells. The electronic device writes one of the initial numerals into the remaining cells.

The electronic device is preferably arranged for selectively deleting characters representing the trial solution numerals from the at least some of the cells. The electronic device is preferably arranged for selectively deleting all of the characters representing the trial solution numerals from selected ones of the cells in response to a character representing only one of the initial numerical values from one to nine being entered into the selected ones of the cells.

The electronic device preferably includes an input arrangement for entering characters representing the solution and/or an initial numerical values from one to nine into selected ones of the cells in response to a user activating the input arrangement. The input arrangement is preferably arranged for enabling the user to select, by column and row, the cells into which are entered characters representing the solution and/or initial numerals.

The electronic device preferably includes a data reading arrangement for entering characters representing the initial numerals into selected ones of the cells in response to a data bearing medium including instructions for the characters representing the initial numeric values of selected column numbers and row numbers that are in the data reading arrangement. Preferably, the data reading arrangement is arranged to read data from a memory medium that a user selectively inserts into and removes from a receptacle of a housing carrying the electronic device.

The matrix is divided into the typical nine 3×3 sub-matrices, each including three columns and three rows of the cells. The electronic device is preferably arranged for selectively deleting the characters representing selected one of the nine different trial solution numerals from a selected row and a selected column and a selected 3×3 matrix of the cells in response to the selected one of the nine different characters being respectively entered as a solution numeral into the selected row and selected column and selected 3×3 matrix by a user using the display to play Sudoku.

A further aspect of the invention relates to a method of using a Sudoku display including a 9×9 matrix of cells arranged in nine columns and nine rows, wherein the display is included in an electronic device having a user input for enabling nine different characters representing the initial numerals from one to nine inclusive to be entered into the cells. The method comprises entering at least some of the characters representing the initial numerals into some of the cells from a Sudoku puzzle source other than the electronic device, and thereafter starting to solve the Sudoku puzzle entered into the cells.

An added aspect of the invention relates to a method of solving a Sudoku puzzle including a display having a 9×9 matrix of cells arranged in nine columns and nine rows, wherein at least some of the cells include nine different characters representing the trial solution numerals from one to nine inclusive. The method comprises selectively deleting characters representing the trial solution numerals from said at least some of the cells.

Preferably, the selective deleting step includes selectively deleting all the characters representing the nine different trial solution numerals from selected ones of the cells in response to a character representing a solution numeral from one to nine being entered into said selected ones of the cells.

The matrix is divided into the typical nine 3×3 sub-matrices, each including three columns and three rows of the cells. The selective deleting step preferably includes selectively deleting a character representing a selected one of the trial solution numerals from a selected row and a selected column and a selected 3×3 sub-matrix of the cells as a result of a character representing said selected one of the nine different solution numerals being respectively entered into said selected row and selected column and selected 3×3 sub-matrix by a user using the display to play Sudoku.

An additional aspect of the invention relates to an electronic device for use in solving Sudoku puzzles, wherein the electronic device includes a display having a 9×9 matrix of cells arranged in nine columns and nine rows. The electronic device has a data reading arrangement for entering characters representing initial numerals from one to nine into selected ones of the cells in response to a data bearing medium including instructions for the characters representing the initial numerals of selected column numbers and row numbers being in the data reading arrangement. The data reading arrangement is arranged to read data from a memory medium that a user selectively inserts into and removed from a receptacle of a housing carrying the electronic device.

Preferably, the electronic device is in a housing having a size, weight and shape enabling it to be carried by one hand of the user.

The above and still further objects, features and advantages of the present invention will become apparent upon consideration of the following detailed description of specific embodiments thereof, especially when taken in conjunction with the accompanying drawings.

### BRIEF DESCRIPTION OF THE DRAWINGS

FIG. 1 is a side view of two attached paper sheets including a Sudoku display in accordance with a first embodiment of my invention;

FIGS. 2A and 2B are front views of the top and bottom sheets, respectively, of FIG. 1;

FIG. 3 is a front view of a handheld housing including an electronic device having a display similar to the display of FIG. 2;

FIG. 4 is a back view of the housing illustrated in FIG. 3;

FIG. 5 is a block diagram of apparatus included in the electronic device in the housing of FIG. 3;

FIG. 6 is a flow diagram of operations that are performed by the electronic device in the housing of FIG. 3; and

FIG. 7 is a flow diagram of optional operations that are performed by the electronic device in the housing of FIG. 3.

### DETAILED DESCRIPTION OF THE DRAWINGS

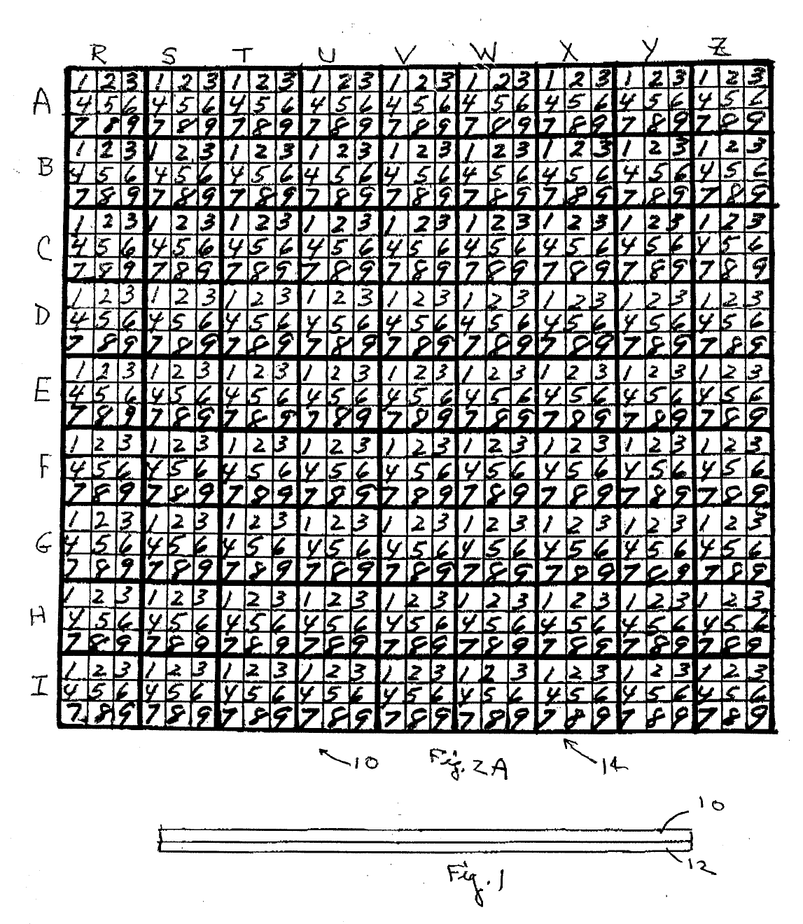

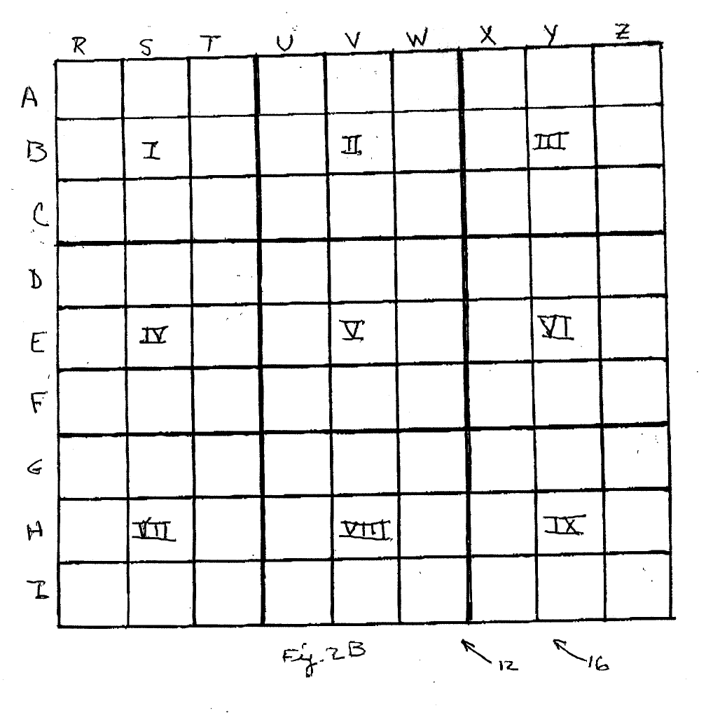

Reference is now made to FIG. 1 of the drawing wherein the top edges of paper sheets 10 and 12 are connected to each other, for example, by a binding, so that top sheet 10 can be folded back to provide access to the top face of bottom sheet 12 that otherwise abuts sheet 10. Bottom sheet 12 is made of a pressure sensitive paper so that when sheets 10 and 12 abut and a stylus applies an image to sheet 10, the image is transferred to and appears on sheet 12.

A 9×9 matrix of square cells is printed on sheets 10 and 12, so that top and bottom sheets 10 and 12 respectively include matrices 14 and 16. The 81 cells of sheets 10 and 12 are in registration when top sheet 10 abuts bottom sheet 12.

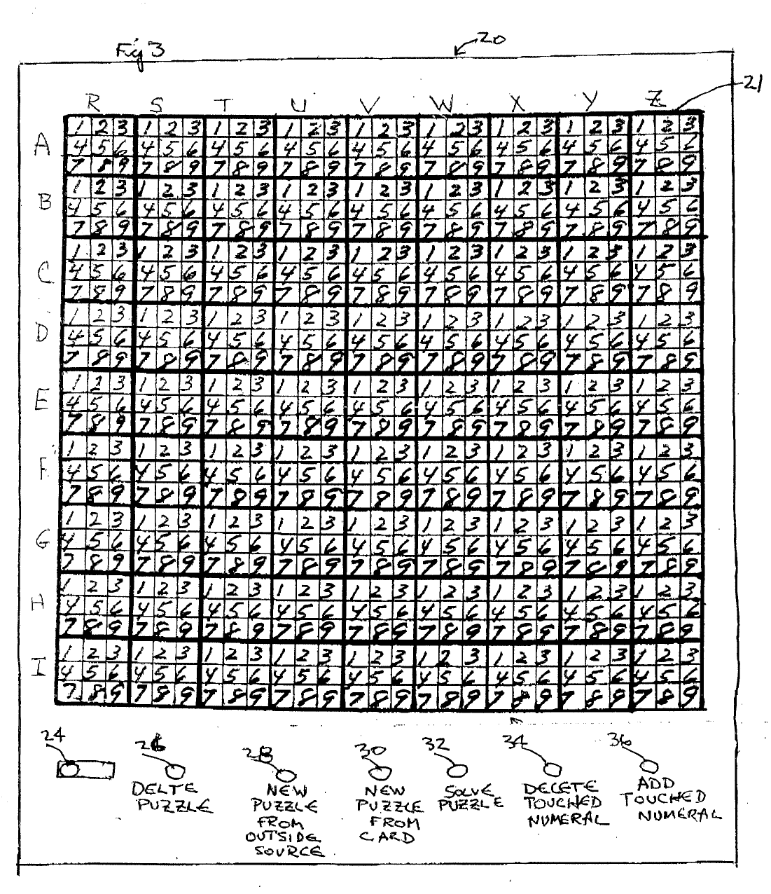

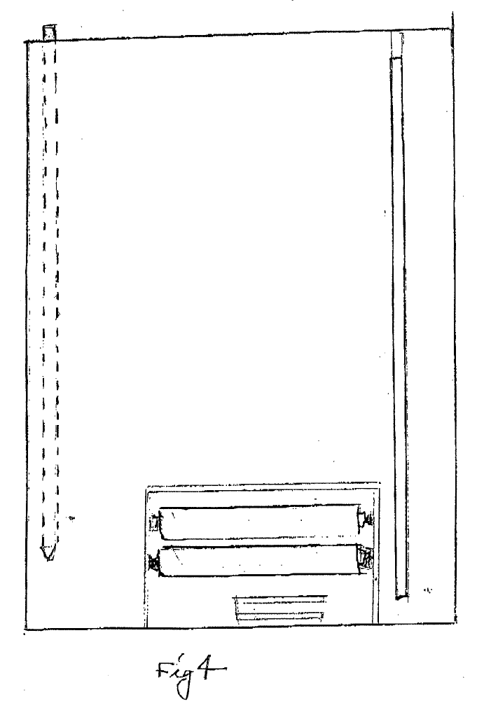

As illustrated in FIG. 2A, sheet 10 includes nine cell rows, respectively bearing the nomenclature A-I, nine cell columns, respectively bearing the nomenclature R-Z, and nine cell sub-matrices, respectively bearing the nomenclature I-IX. Each of the nine cell sub-matrices bearing the nomenclature I-IX includes a 3×3 matrix of three columns and three rows of the cells so that sub-matrix I includes the cells in rows A, B, and C at columns R, S and T, sub-matrix II includes the cells in rows A, B, and C at columns U, V and W, sub-matrix III includes the cells in rows A, B, and C at columns X, Y and Z, sub-matrix IV includes the cells in rows D, E, and F at columns R, S and T, sub-matrix V includes the cells in rows D, E, and F at columns U, V and W, sub-matrix VI includes the cells in rows D, E, and F at columns X, Y and Z, sub-matrix VII includes the cells in rows E, H and I at columns R, S and T, sub-matrix VIII includes the cells in rows E, H and I at columns U, V and W, and sub-matrix IX includes the cells in rows E, H and I at columns X, Y and Z. The color of Roman numerals I-IX differs from the color of numerals 1-9 in the sub cells to enable a user to distinguish the numerals I-IX from the numerals 1-9. Numerals I-IX are superimposed on numerals in the center cell of each sub-matrix. To simplify the drawing, numerals I-IX are shown only on FIG. 2B.

Each of the 81 cells of sheet 10 includes nine square sub-cells arranged in a 3×3 sub-sub-matrix, resulting in a total of 729 sub-cells on the sheet. The nine sub-cells of each cell contain characters representing the numerals 1-9; the numerals 1-9 in the sub-cells are referred to herein as trial solution numerals.

As illustrated in FIG. 2B, sheet 12 is similar to sheet 10 in that sheet 12 has markings in the form of a 9×9 matrix of square cells that are arranged in the same way as the cells of sheet 10, so that the cells in the nine rows and nine columns of sheet 12 are divided into nine 3×3 sub-matrices in registration with the cells of the nine 3×3 sub-matrices of sheet 10 bearing the nomenclature I-IX when sheets 10 and 12 abut. The 81 cells of sheet 12, however, do not include any sub-cells or characters representing trial solution numerals.

Prior to beginning to solve the Sudoku puzzle, the characters representing numerals from a source puzzle (referred to herein as initial numerals), such as a newspaper, magazine or book, are written by a stylus, such as a pen, into the appropriate cells on sheet 10 and are transferred to the cells on sheet 12 that are in registration with the appropriate cells on sheet 10, due to the pressure sensitive nature of sheet 12. A thick sheet (not shown) that prevents pressure from a stylus applied to sheet 10 from being transferred to sheet 12, such as thick cardboard, is then inserted between sheets 10 and 12.

With the thick sheet in place between sheets 10 and 12, a person attempting to solve the puzzle, that is, a user, deletes the characters representing inappropriate trial solution numerals from the sub-cells in the rows, columns and sub-matrices of sheet 10 so that: (1) in a particular row, the cells having a numeral do not have the same numeral, (2) in a particular column, the cells having a numeral do not have the same numeral, and (3) in a particular sub-matrix, the cells having a numeral do not have the same numeral. After these operations, except for very easy puzzles, there is at least one cell having multiple characters in at least one row, column and/or sub-matrix.

The user then removes the thick sheet between sheets 10 and 12 and causes transfer of the remaining trial solution numerals from the sub-cells in the rows, columns and sub-matrices in cells of sheet 10 to corresponding cells of sheet 12 by tracing the stylus over the remaining trial solution numerals in the sub-cells of sheet 10. The user then attempts to solve the puzzle by eliminating the inappropriate characters representing the trial solution numerals 1-9 from the cells of sheet 12 so that there is a single, different character in each column, row and sub-matrix of sheet 12 (the single, different character in each column, row and sub-matrix of sheet 12 is referred to herein as a solution numeral).

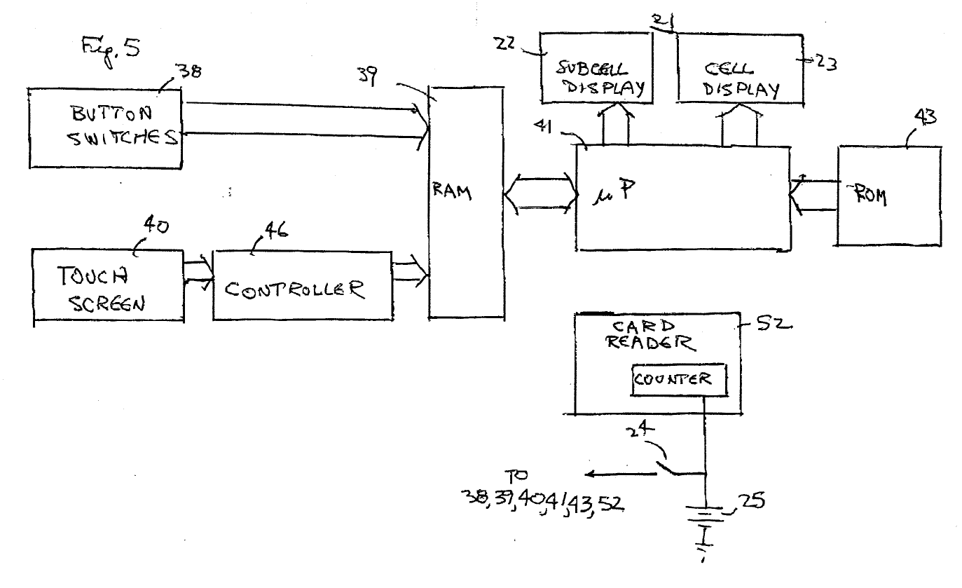

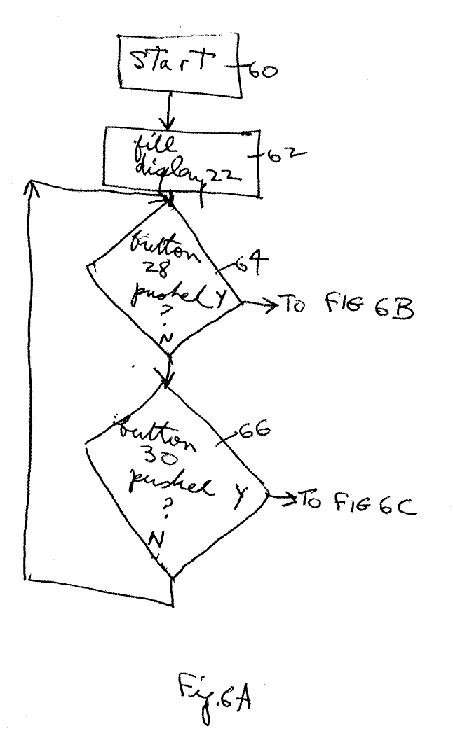

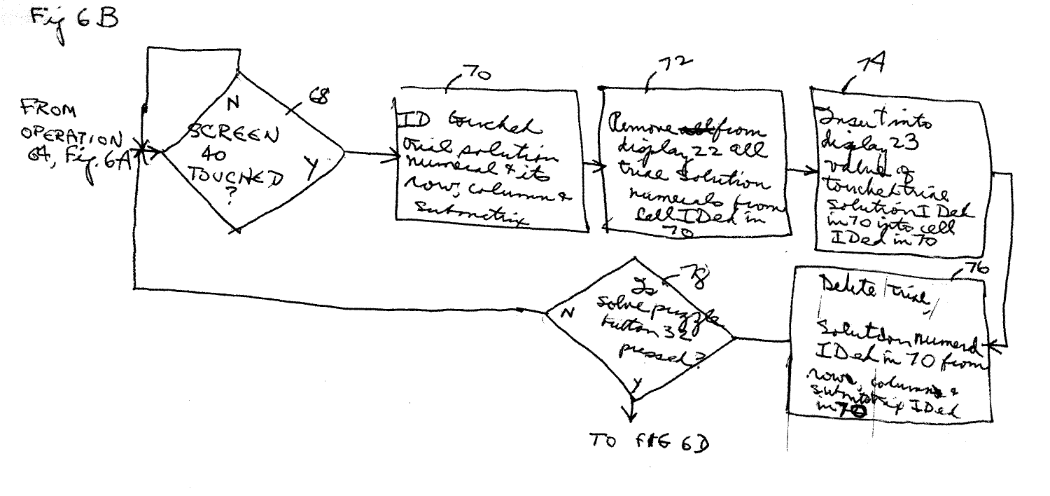

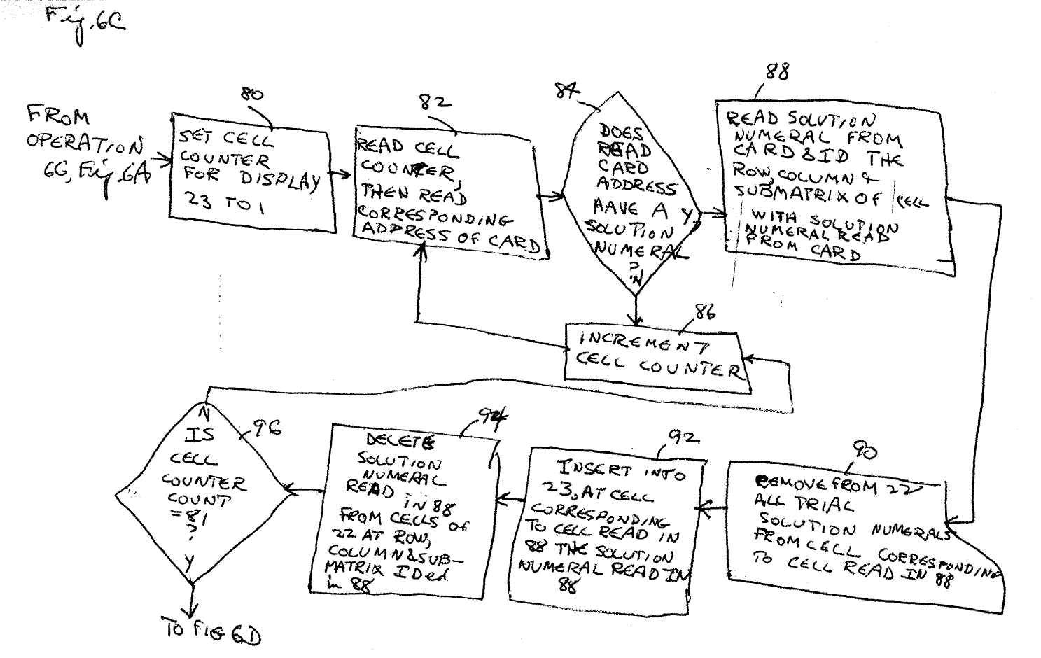

Reference is now made to FIGS. 3-5 of the drawing wherein housing 20, that is sufficiently small, light weight and shaped to be carried in one hand of a user, includes on its front face liquid crystal display (LCD) 21 that is initially configured to have the same display as the display on sheet 10 and is subsequently configured to have the same display as the display on sheet 12. For convenience the foregoing configurations of display 21 are considered to be separate displays 22 and 23, such that display 22 can be considered as a sub-cell display having 729 square sub-cells containing the 729 trial solution numerals and display 23 can be considered a cell display having 9×9=81 square cells into which initial and solution numerals are inserted. The front face of housing 20 also includes on-off switch 24 for turning on and off the flow of current from batteries 25 (FIGS. 4 and 5) to battery-powered electronic circuitry (FIG. 5) in housing 20.

The front face of housing 20 also includes “delete puzzle” button 26, “new puzzle from outside source” button 28, “new puzzle from card” button 30, “solve the puzzle” button 32, “delete touched numeral” button 34, and optional “add touched numeral” button 36. Each of buttons 26-36 is associated with a separate one of on-off button switches 38 (FIG. 5), having connections to random access memory (RAM) 39, having an output bus connected to the electronic circuitry in housing 20 so that signals on the output bus of the RAM are supplied to microprocessor 41 under control of a program stored in read only memory (ROM) 43. Microprocessor 41 can also load signals into RAM 39.

Closure of the switches 38 associated with buttons 26-36 and the resulting signals RAM 39 derives assist in enabling microprocessor 41 to control display 21. RAM 39 includes designated memory addresses for storing the activated states of buttons 26-36.

The memory addresses in RAM 39 associated with activation of buttons 28 and 30 respond to closure of the switches associated with buttons 28 and 30 to indicate a new puzzle is being entered from an outside source and from a memory card, respectively. The memory addresses associated with buttons 28 and 30 remain in such a state until the user activates “solve the puzzle” button 32, at which time the memory 39 addresses associated with buttons 28 and 30 revert to the initial state thereof, indicating that a new puzzle is no longer being entered, and the designated address in RAM 39 associated with button 32 is activated to indicate the puzzle is in the process of being solved. The designated address in RAM 39 associated with button 32 remains in such a state until the puzzle is solved or on-off switch 24 is activated to the off state.

Shortly after the designated address in RAM 39 associated with “solve the puzzle” button 32 has been activated to indicate the puzzle is in the process of being solved, a user typically presses “delete” button 34, causing the designated address in RAM 39 associated with button 34 to be activated to a state to indicate numerals are to be deleted from sub-cells of display 22. The designated address in RAM 39 associated with button 34 remains activated to such a state until the user presses “add” button 36 or until the puzzle is solved or on-or switch 24 is activated to the off state. The designated address in RAM 39 associated with “add” button 36 is activated to a state to indicate numerals are to be added to sub-cells of display 22 in response to the switch associated with button 36 being closed. The designated address in RAM 39 associated with button 36 remains activated to such a state until the user presses “delete” button 34 or until the puzzle is solved or on-or switch 24 is activated to the off state.

Superimposed on display 21 is optically transparent touchscreen 40 (FIG. 5), having sufficient resolution to determine which of each of the 729 sub-cells of display 22 is touched by stylus 42 (FIG. 4) that is stored in a cavity in housing 20. In response to stylus 42 being pressed against a particular sub-cell of display 22, controller 44 (FIG. 5) supplies a signal to random access memory (RAM) 39 indicative of the identity of the particular sub-cell. The sub-cell signals controller 44 derives are coded in accordance with Sm,n,o,p, where:

m is the number of the touched sub-cell (from 1 to 9) in a particular cell Cn,o,p,

n indicates the row (from A to 1) where cell Cn,o,p is located,

o indicates the column (from R to Z) where cell Cn,o,p is located, and

p indicates the sub-matrix (from I to IX) where cell Cn,o,p is located.

RAM 39 responds to the sub-cell signals derived by controller 46 to supply the sub-cell signals stored therein to microprocessor 41 under the control of the program stored in read-only memory 43. Microprocessor 41 responds, under control of the program stored in read-only memory 43, to the signals RAM 39 supplies to the RAM output bus in response to signals from button switches 38 and controller 46 to selectively activate the numerals 1-9 in different ones of the 729 sub-cells of sub-cell display 22.

Display 23 is initially configured to have the same markings as the markings on sheet 12; thus display 23 includes 81 separate, square cells and display 23 is considered to be a cell display. Each of the 81 separate, square cells of display 23 is selectively activated by microprocessor 41 to display each of the numerals 1-9 in a region that encompasses several of the sub-cells, and occupies a significant portion, of each cell so that the numerals displayed in the cells are substantially larger than the numerals displayed in the sub-cells. Microprocessor 41 responds, under control of the program stored in read-only memory 43, to the signals RAM 39 supplies to the RAM output bus in response to signals from button switches 38 and controller 46 to selectively activate the larger numerals 1-9 in different ones of the 81 cells of cell display 23.

Microprocessor 41 is programmed to activate display 21 so that the sub-cells of display 22 in corresponding cells of display 23 are in registration. Microprocessor 41 is programmed such that display of a larger numeral in a particular one of the cells of cell display 23 results in display of none of the numerals in the sub-cells of the corresponding cell of sub-cell display 22. Hence, in response to a larger numeral being displayed in a particular cell of cell display 23 a user, except under one circumstance, perceives only that larger numeral in the particular cell of cell display 23 and perceives none of the small trial solution numerals associated with the sub-cells in the particular cell of sub-cell display 22.

New puzzles can be inserted into housing 20 at will. To this end, housing 20 includes a receptacle in the form of slot 50 (FIG. 4) for receiving a memory card (not shown) that a user can manually insert into and remove from the slot; the memory card stores the values and locations of initial numerals for many puzzles. The cards can include different puzzles having differing degrees of difficulty or different cards can have puzzles with differing degrees of difficulty. If a single card has different puzzles with differing degrees of difficulty, appropriate buttons and associated switches can be provided on housing 20 to control reading of appropriate puzzles from the card by microprocessor 41.

Within slot 50 is card reader 52 (FIG. 5) that supplies to microprocessor 41 signals indicative of the values and locations of the initial numerals for a particular puzzle. Card reader 52 includes counter 54 that keeps track of the number of the particular puzzle being read by card reader 52. Counter 54 is always supplied with a trickle charge by battery 25 and is incremented by a count of one each time switch 24 is closed so that a different puzzle can be solved by the user each time the user wants to solve a puzzle by using a card. To solve a new puzzle that is on a card, the user presses “new puzzle from card” button 30 immediately after activating on-off switch 24 to the “on” position. Hence, the card and card reader 52 provide a data input arrangement for entering characters representing only one of the initial numerals from one to nine into selected ones of the cells in response to a data bearing medium including instructions for the initial numerals of selected columns and rows being in the data input arrangement.

Alternatively, a user can insert new puzzles into housing 20 from external sources, such as a newspaper, magazine or book. To this end, the user presses “new puzzle from outside source” button 28 immediately after activating on-off switch 24 to the “on” position. In response to the user pressing button 28, microprocessor 41 is programmed to cause sub-cell display 22 to display the 729 initial sub-cell numerals as illustrated in FIG. 2. The user then presses stylus 42 against each of the sub-cells having numerals corresponding with the numerals in the cells of the outside source. Hence, for example, if the outside source has the numeral 2 in the third row and fourth column, the user presses stylus 42 against the sub-cell bearing numeral 2 in the cell at row C and column U. These actions cause microprocessor 41 to (1) activate cell display 23 to display the large numeral 2 in the cell at row C and column U, and (2) deactivate all the small sub-cell numerals (that is, trial solution numerals) in the cell at row C and column U of sub-cell display 22. The user continues in this manner until all the initial numerals have been entered in display 23.

After all the initial numerals have been entered in display 23, in response to the user entering the initial numerals from an external source, the user activates “solve the puzzle” button 32. In response to button 32 being activated, microprocessor 41 is programmed to delete, from subcell display 22, all the trial solution numerals that (1) are in the same row, column and sub-matrix of an initial numeral and (2) have the same numeral as the initial numeral. For example, if the initial numeral 2 is in the cell at row C and column U, that is, in sub-matrix II, microprocessor 41 deletes, from subcell display 22, all the small trial solution numerals 4 in the sub-cells of the cells at row C, column U and sub-matrix II. Microprocessor 41 continues with this process until all the appropriate trial solution numerals in the appropriate rows, columns and submatrices have been deleted from subcell display 22.

At this time, the user typically begins to solve the puzzle by pressing stylus 42 against appropriate sub-cells on touchscreen 40. Touchscreen 40 responds to stylus 42 being pressed against the sub-cells on the touchscreen by causing controller 46 to supply Sm,n,o,p signals to RAM 39 indicative of the trial solution numerals associated with the pressed, that is, touched, subcells and the designations of the row (A-I), column (R-Z) and sub-matrix (I-IX) of the touched subcells. The Sm,n,o,p signals are stored in designated addresses in RAM 39 and are read by microprocessor 41. Microprocessor 41 responds to each Sm,n,o,p signal by deleting, from subcell display 22, the trial solution numeral associated with the touched subcell. Hence, as the user continues to press stylus 42 against additional appropriate subcells on touchscreen 40, microprocessor 41 deletes from subcell display 42 the trial solution numerals associated with the touched subcells.

The program that read-only memory 43 stores controls microprocessor 41 so that in response to the microprocessor activating subcell display 22 so only one remaining trial solution numeral is displayed in a particular cell, all of the small trial solution numerals in the particular cell are deleted from display 22 and the remaining trial solution numeral is displayed as a large solution numeral in the corresponding cell of cell display 23. Microprocessor 41 is also controlled by memory 43 to remove the one remaining trial solution numeral from the cells of subcell display 22 that are in the same row, column and sub-matrix as the cell having the one remaining trial solution numeral. For example, if the numeral 2 is the only remaining trial solution numeral in the cell at row C and column U, that is, in sub-matrix II, microprocessor 41 deletes, from subcell display 22, all the small trial solution numerals 4 in the sub-cells of the cells at row C, column U and sub-matrix II.

If the user realizes he has made a mistake by deleting a trial solution numeral from a particular subcell, the user presses optional “add” button 36. Pressing button 36 activates button switches 38 and RAM 39 to cause microprocessor 41 to activate subcell display 22 to the initial condition thereof, so that the 729 trial solution numerals are displayed on subcell display 22 simultaneously with the solution numerals that have been previously displayed on cell display 23. The user then presses stylus 42 against the mistakenly deleted subcell, causing deletion from subcell display 22 of all the previously deleted trial solution numerals, except for the pressed, mistakenly deleted trial solution numeral and the trial solution numerals in the cells at the same row, column and sub-matrix as the mistakenly deleted trial solution numeral. Hence, the display has been restored to the same condition that it had prior to the mistaken deletion of a trial solution numeral. The user then continues to solve the puzzle by microprocessor automatically reverting to a “delete trial solution numeral” mode or by the user pressing “delete” button 34.

When the puzzle has been completed or if the user believes the puzzle is too difficult for the user to solve, the user presses “delete puzzle” button 26. Button switches 38 and RAM 39 respond to pressing of button 26 to activate microprocessor 41 to restore display 22 to the initial condition thereof, that is, display of the 729 trial solution numerals, and deactivation of cell display 23.

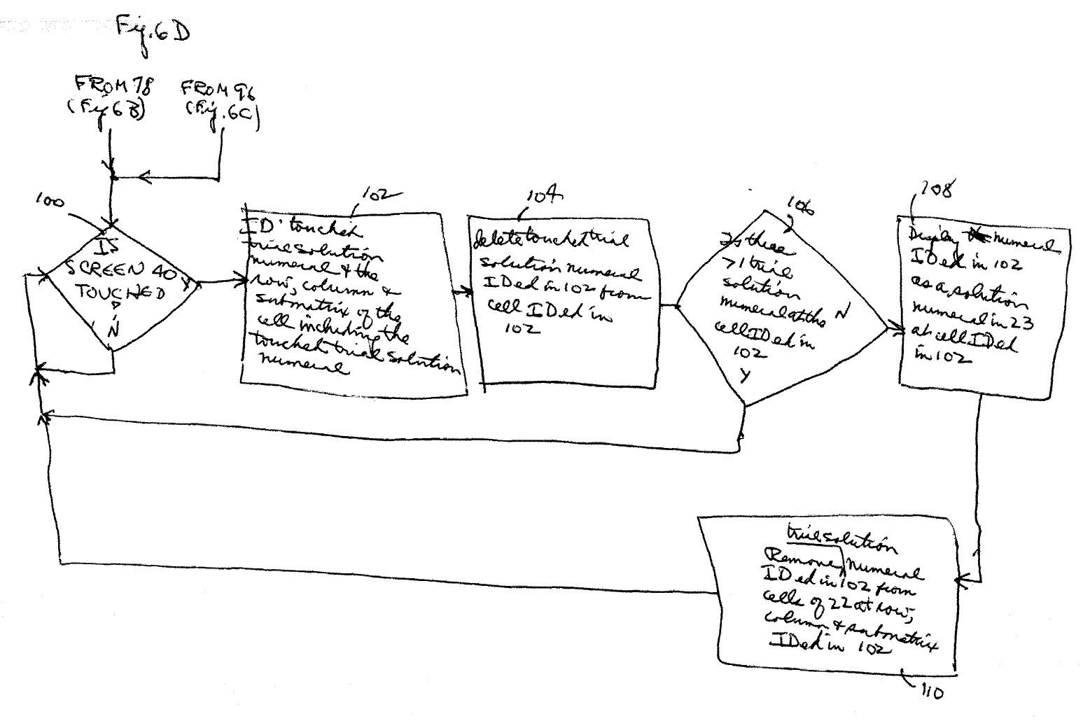

Reference is now made to FIG. 6 of the drawing, a flow diagram of operations microprocessor 41 performs in response to the program stored in read only memory 43 that is responsive to a clock source (not shown) of microprocessor 41, as well as inputs from RAM 39 and card reader 52. The program starts (operation 60) in response to on-off switch 24 being closed and proceeds to operation 62, during which microprocessor 41 responds to memory 43 to load the 729 subcells of display 22 with the 729 trial solution numerals.

Microprocessor 41 then, during operation 64, reads the signal at the designated address of RAM 39 where an indication of the present or immediately preceding state of “new puzzle from outside source” button 28 is stored. In response to operation 64 indicating that button 28 has not been pressed, the program advances to operation 66, during which the signal at the designated address of RAM 39 that stores an indication of the present or immediately preceding state of “new puzzle from card” button 30. In response to operation 66 indicating button 30 has not been pressed, the program returns to operation 64 in a do over (DO) loop. The do over loop continues until one of operations 64 or 66 indicates button 28 or 30 has been pressed.

In response to operation 64 indicating “new puzzle from outside source” button 28 has been pressed, the program advances to operation 66, during which microprocessor 41 responds to the designated address in RAM 39 that is responsive to controller 46 providing an indication of touchscreen 40 being touched. In response to operation 68 indicating touchscreen 40 is not being touched, microprocessor 41 repeatedly reads the designated address in RAM 39 where the indication of touching of touchscreen 40 is stored until that designated address indicates the touchscreen has been touched.

In response to operation 68 indicating touchscreen 40 has been touched, the program advances microprocessor 41 to operation 70, during which microprocessor 41 reads the designated addresses in RAM 39 that store outputs of controller 46 indicative of the identification of the touched trial solution numeral, as well as the identification of the row, column and sub-matrix of the cell in which the touched trial solution numeral is located. The program then causes microprocessor 41 to advance to operation 72, during which the microprocessor activates display 22 to remove from display 22 all trial solution numerals from the cell identified during operation 70. The program then advances microprocessor 41 to operation 74, during which the microprocessor activates display 23 to insert into display 23 the value of the touched trial solution numeral into the identified cell. Hence, the value of the touched trial solution numeral in the identified cell (that is a small character in a sub-cell of display 22) is transferred to the identified cell in display 23 as a solution numeral that is considerably larger in area than the touched trial solution numeral.

After operation 74 has been completed, the program advances microprocessor 41 to state 76, during which the microprocessor activates display 22 so that the small character associated with the touched trial solution numeral is deleted from the cells at the identified row, column and sub-matrix read by microprocessor 41 during operation 70. Hence, at this time, a user who looks at display 21 sees in the cell of display 23 containing the touched trial solution numeral, a large solution numeral having a value equal to the touched small trial solution numeral in display 22. At the same time, the user sees some small trial solution numerals (but not the touched trial solution numeral) in the subcells of display 22 at the cells in the same row, column and sub-matrix as the touched trial solution numeral.

After operation 76 has been completed, the program advances microprocessor 41 to operation 78, during which the microprocessor reads the designated address in RAM 39 where an indication of the present or immediately preceding state of “solve puzzle” button 32 is stored. In response to operation 78 indicating button 32 has not been pressed, the program causes microprocessor 41 to return to operation 68, and operations 68-78 are repeated until operation 78 indicates “solve puzzle” button 32 has been pressed. Since the user presses button 32 only after all clues of the external source have been entered, the puzzle is ready to be solved by the user.

If the puzzle is to be read from the card in reader 52, rather than being entered by the user from an external source, microprocessor 41 eventually reads, during operation 66, from the designated address in RAM 39 associated with the state of “new puzzle from card” button 30, that button 30 has been pressed. In response to operation 66 indicating button 30 has been pressed, the program in read-only memory 43 advances microprocessor 41 to state 80, during which a cell counter in microprocessor 41 is set to a count of one. The cell counter keeps track of the cell in display 23 that is to be loaded with a solution numeral clue; the clue is stored in a cell of the memory card that corresponds with the cell in display 23. The cell counter has a capacity of at least 81 counts, one for each of the 81 cells of display 23.

The card in card reader 52 is arranged so that it includes 81 addresses, one for each cell of display 23. At each of the 81 addresses of the card is an indication of whether the corresponding cell of display 23 is or is not to be supplied with a clue in the form of a solution numeral. If the corresponding cell of display 23 is to be supplied with a clue, the address stores a signal indicative of the value of the solution numeral at the address.

After operation 80 has been completed, the program advances microprocessor 41 to operation 82, during which the microprocessor reads the count in the cell counter that in turn controls reading of the corresponding address of the card in card reader 52. Next, operation 84 determines whether the corresponding address of the card in card reader 52 stores a signal indicative of a solution numeral. In response to operation 84 indicating the corresponding address of the card in card reader 52 does not store a signal for a solution numeral, the program advances microprocessor 41 to operation 86, during which the cell counter of the microprocessor is incremented by a count of one. Upon completion of operation 86, microprocessor 41 returns to operations 82 and 84 in a do over loop that is repeated until operation 84 indicates the corresponding address of the card in card reader 52 stores a signal for a solution numeral.

Then the program in read-only memory 43 advances microprocessor 41 to operation 88 during which the microprocessor reads from the address of the card in card reader 52 associated with the count in the cell counter a signal indicative of the value of the solution numeral (clue) at the address of the card associated with the count in the cell counter of microprocessor 41. Microprocessor 41, during operation 88, converts the count in the cell counter thereof into an indication of the row, column and sub-matrix of the cell containing the solution numeral under consideration.

Next, microprocessor 41 advances to state 90, during which the microprocessor activates display 22 so that all the small trial solution numerals in the sub-cells of the cell identified during operation 88 are deleted. Then microprocessor 41 advances to state 92, during which the microprocessor activates display 23 so that the solution numeral stored in the card in card reader 52 at the cell identified during operation 88 is displayed at the corresponding cell of display 23. The program stored in read-only memory 43 then advances microprocessor 41 to operation 94, during which the microprocessor activates display 22 to delete the trial solution numeral equal to the solution numeral (clue) from the cells in the same row, column and sub-matrix as the cell that was identified during operation 88.

Upon the completion of operation 94, the program advances microprocessor 41 to operation 96, during which the microprocessor determines whether the cell counter count is or is not equal to 81. In response to the cell count not being equal to 81, the program returns to operation 86, during which the cell counter is incremented by a count of one. Then, the process is repeated by returning to operations 82-96 until operation 96 indicates the cell counter count equals 81.

In response to operation 78 indicating “solve puzzle” button 32 being pressed or operation 96 indicating the count of the cell counter has reached 81, the puzzle is ready to be solved by the user and read-only memory 43 advances microprocessor 41 into a “delete trial solution numeral” mode. In the “delete trial solution numeral” mode, microprocessor 41 responds to signals in RAM 39 at designated addresses associated with controller 46 to remove, that is delete, trial solution numerals from touched sub-cells of display 22.

The first operation microprocessor 41 performs in the “trial solution numeral” mode is to determine if touchscreen 40 is being touched (operation 100). Operation 100 is repeated until controller 46 signals RAM 39 that touchscreen 40 is being touched, at which time the program in read-only memory 43 advances microprocessor 41 to operation 102. During operation 102, microprocessor 41 performs the same operations that it performs during operation 70, to identify the touched trial solution numeral and identify the row, column and sub-matrix of the cell including the touched trial solution numeral. Then, microprocessor 41 advances to operation 104, during which the microprocessor activates display 22 to delete the touched solution numeral at the sub-cell identified during operation 102.

Upon completion of operation 104, the program advances microprocessor 41 to operation 106 during which the microprocessor determines if there is more than one trial solution numeral at the cell identified during operation 102. In response to operation 106 indicating there is more than one trial solution numeral at the cell identified during operation 102, the program returns to operation 100 and operations 100-106 are performed in response to the user touching different sub-cells of display 22. Operations 100-106 are repeated until operation 106 indicates there is only one trial solution numeral at the cell identified during the immediately preceding operation 102.

In response to operation 106 indicating there is only one trial solution numeral at the cell identified during the immediately preceding operation 102, microprocessor 41 advances to operation 108. During operation 108, microprocessor 41 activates display 23 so that the cell identified during operation 102 displays the trial solution numeral identified during operation 102, that is, the trial solution numeral that was most recently touched on touchscreen 40. The program of read-only memory 43 then advances microprocessor 41 to operation 110. During operation 110, microprocessor 41 removes from the sub-cells of display 22, at the cells in the row, column and sub-matrix identified during the immediately preceding operation 102, the trial solution numerals having the same value as the trial solution numeral identified during the immediately preceding operation 102.

Upon completion of operation 110, the program stored in read-only memory 43 causes microprocessor 41 to return to operation 100. Microprocessor 41 continues to operate in this manner, between operations 100 and 110, until the user has correctly pressed stylus 42 against the sub-cells of display 22 so all the cells of display 23 are filled with the correct solution numerals, that is, so the solution numerals 1-9 are in each of rows A-I and columns R-Z and sub-matrices I-IX of display 23. Microprocessor 41 can include an arrangement for detecting the presence of the solution numerals 1-9 in each of rows A-I and columns R-Z and/or sub-matrices I-IX of display 23 and include an actuator for a visual and/or audio indicator to signal that the puzzle has been solved.

An additional, optional feature enables a user to add trial solution numerals to display 22 if the user has realized that he/she has made a mistake and there is a need to restore trial solution numerals that have been erroneously deleted from display 22. Such operation is performed in response to the user activating “add” button 36.

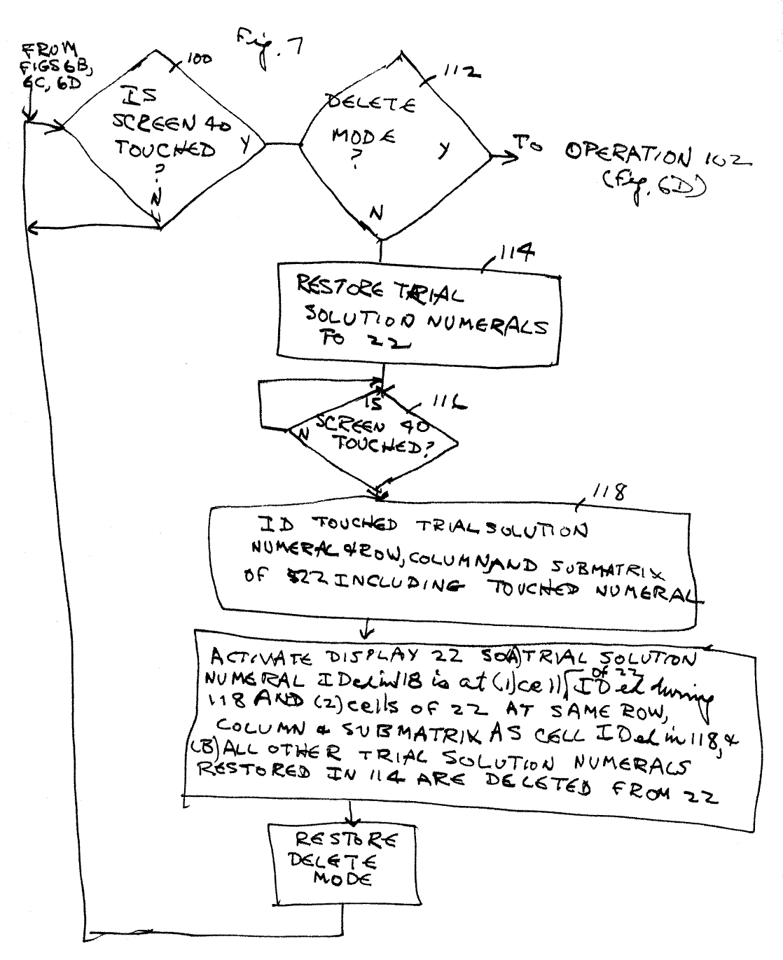

To this end, the program stored in read-only memory 43 is modified to include operation 112, FIG. 7, between operations 100 and 102. In operation 112, microprocessor 41 reads designated memory addresses in RAM 39 that indicate whether display 22 is in the “delete solution numeral” or “add solution numeral” mode. RAM 39 responds to microprocessor 41 going from operation 78 or operation 96 to operation 100 by setting the designated memory address in the RAM for the “delete solution numeral” mode to indicate display 22 is in the “delete solution numeral” mode. During normal operation of microprocessor 41, as described in connection with FIG. 6, operation 112 determines that microprocessor 41 is not operating in the “add solution numeral” mode and microprocessor 41 proceeds from operation 100 to operation 102.

In response to the user realizing that he/she has made a mistake and there is a need to add solution numerals to display 22, the user presses, that is activates, “add” button 36. During operation 112 microprocessor 41 reads from the designated address of RAM 39 that “add” button 36 has been activated, causing the microprocessor to advance from operation 112 to operation 114. During operation 114, microprocessor 41 activates display 22 to restore the trial solution numerals to all cells, except the cells containing the initial solution numerals loaded by the user or the card reader. This enables the user to accurately place stylus 42 on a desired trial solution sort cell of display 22. Then microprocessor 41 advances to operation 116.

During operation 116, microprocessor 41 reads the designated address in RAM 39 indicating whether touchscreen 40 is being touched. The microprocessor stays in operation 116 until the designated RAM address indicates touchscreen 40 is being touched. In response to operation 116 indicating touchscreen 40 is being touched, the program advances microprocessor 41 to operation 118, during which microprocessor 41 responds to the signal in a designated address of RAM 39 indicative of the touched sub-cell that controller 46 indicates is associated with the trial solution numeral that the user wants to restore to display 22. Hence, during operation 118, microprocessor 41 identifies the trial solution numeral (from 1-9) that is to be added to display 22, and the row and column of the cell to which the trial solution numeral is to be added. During operation 118, microprocessor 41 also identifies the sub-matrix where the added trial solution numeral is to be added to display 22.

After operation 118, microprocessor 41 advances to operation 120, during which the microprocessor activates display 22 to display the added trial solution numeral at (1) the appropriate sub-cell in the cell identified during operation 118, and (2) the sub-cells of the cells in the same row, column and sub-matrix as the cell identified during operation 118. During operation 120, microprocessor 41 also deletes all other trial solution numerals that were restored during operation 114. Hence, upon completion of operation 120, displays 22 and 23 have the same trial solution numerals and solution numerals as prior to operation 114, except for the trial solution numeral that was added to (1) the cell identified during operation 118 and (2) the cells in the same row, column and sub-matrix as the cell identified during operation 118.

Upon completion of operation 120, program 43 advances microprocessor 41 to operation 122, during which the designated addresses in RAM 39 are activated to indicate microprocessor 41 is to be restored to the “delete trial solution” mode. Upon completion of operation 122, microprocessor 41 returns to operation 100, to determine if screen 40 is being touched. Operation then proceeds in the “delete trial solution” mode until the puzzle is completed or the “add trial solution” mode is again entered.

While there have been described and illustrated specific embodiments of the invention, it will be clear that variations in the details of the embodiments specifically illustrated and described may be made without departing from the true spirit and scope of the invention as defined in the appended claims. For example, the electronic version of the invention can be practiced by using a personal computer of the desktop or laptop variety. In such a case, the Internet, or storage media such as a memory stick, CD, DVD or floppy disk can be used to load puzzle clues and/or the control program into a hard disk of the personal computer, or by a user using a keyboard or mouse to enter clues in the form of solution numerals from an external puzzle into a display of the computer. In addition, other portable electronic devices, such as personal digital assistants (PDAs) or mobile cellular telephones (with appropriate modification), can be employed. In addition, many of the functions performed in response to touching of touchscreen 40 can be performed through the use of a more comprehensive keyboard having keys would nomenclatures associated with the rows, columns and submatrices.

What is claimed is:

1. A display for use in solving a Sudoku puzzle comprising a tangible medium including a 9×9 matrix of cells arranged in nine columns and nine rows, at least some of the cells including nine different characters representing trial solution numerals from one to nine inclusive.

2. The display of claim 1 wherein each of the cells includes nine different characters representing the trial solution numerals from one to nine inclusive.

3. The display of claim 2 wherein the tangible medium includes a sheet.

4. The display of claim 1 wherein the tangible medium includes a first sheet stacked with a second sheet having a second 9×9 matrix of cells arranged in registration with the cells of claim 1, the cells of the second sheet being adapted to have characters representing initial and/or solution numerals from one to nine inclusive inserted thereon in response to a user using the display to (1) enter characters representing initial numerals into the display and/or (2) solve the puzzle.

5. An electronic device in combination with the display and tangible medium of claim 1, the electronic device being arranged for writing nine different characters representing initial and/or solution numerals from one to nine into said at least some of the cells.

6. The electronic device of claim 5 wherein the electronic device is arranged for selectively deleting characters representing trial solution numerals from said at least some of the cells.

7. The electronic device of claim 6 wherein the electronic device is arranged for selectively deleting all the nine different characters representing the trial solution numerals from selected ones of the cells in response to a character representing solution and/or initial numerals from one to nine being entered into said selected ones of the cells.

8. The electronic device of claim 7 wherein the electronic device includes an input arrangement for entering characters representing initial and/or solution numerals from one to nine into selected ones of the cells in response to a user activating the input arrangement.

9. The electronic device of claim 8 wherein the input arrangement is arranged for enabling the user to select, by column designation and row designation, the cells into which characters representing initial and/or solution numerals are entered.

10. The electronic device of claim 8 wherein the input arrangement is arranged for enabling the user to select, by column and row, the cells into which characters representing initial and/or solution numerals are entered.

11. The electronic device of claim 7 wherein the electronic device includes a data reading arrangement for entering characters representing initial numerals from one to nine into selected ones of the cells in response to a data bearing medium including instructions for the initial numerals of selected column numbers and row numbers being in the data reading arrangement.

12. The electronic device of claim 11 wherein the data reading arrangement is arranged to read data from a memory medium that a user can selectively insert into and remove from a receptacle of a housing carrying the electronic device.

13. The electronic device of claim 6 wherein the matrix is divided into nine 3×3 sub-matrices, each including three columns and three rows of the cells, and the electronic device is arranged for selectively deleting a selected one of the nine different characters representing trial solution numerals from a selected row and a selected column and a selected 3×3 sub-matrix of the cells in response to a character representing the selected one of the trial solution numerals being respectively entered, as the solution numeral, into said selected row and selected column and selected 3×3 matrix by a user using the display to play Sudoku.

14. A method of using a Sudoku display including a 9×9 matrix of cells arranged in nine columns and nine rows, the display being included in an electronic device having a user input for enabling nine different characters representing numerals from one to nine inclusive to be entered as initial numerals into the cells, the method comprising entering at least some of the characters representing the initial numerals into some of the cells from a Sudoku puzzle source other than the electronic device, and thereafter starting to solve the Sudoku puzzle entered into the cells.

15. A method of solving a Sudoku puzzle including a display including a 9×9 matrix of cells arranged in nine columns and nine rows, at least some of the cells including nine different characters representing trial solution numerals from one to nine inclusive, the method comprising selectively deleting characters representing the trial solution numerals from said at least some of the cells.

16. The method of claim 15 wherein the selective deleting step includes selectively deleting all of the nine different characters representing the trial solution numerals from selected ones of the cells in response to a character representing the solution numeral being entered into said selected ones of the cells.

17. The method of claim 16 wherein the matrix is divided into nine 3×3 sub-matrices, each including three columns and three rows of the cells, and the selective deleting step includes selectively deleting a selected one of the nine different characters representing the trial solution numerals from a selected row and a selected column and a selected 3×3 sub-matrix of the cells as a result of said selected one of the nine different characters being respectively entered into said selected row and selected column and selected 3×3 matrix by a user using the display to play Sudoku.

18. The method of claim 15 wherein the display is included in an electronic device having a user input for enabling nine different characters representing initial and/or solution numerals from one to nine inclusive to be entered into the cells, the selective deleting of characters representing the trial solution numerals from said at least some of the cells being performed by a user entering characters representing the initial and/or solution numerals into the user input.

19. The method of claim 16 wherein the display is included in an electronic device having a user input for enabling nine different characters representing initial and/or solution numerals from one to nine inclusive to be entered into the cells, the selective deleting of characters representing the trial solution numerals from said at least some of the cells being performed by a user entering characters representing the initial and/or solution numerals into the user input.

20. The method of claim 17 wherein the display is included in an electronic device having a user input for enabling nine different characters representing initial and/or solution numerals from one to nine inclusive to be entered into the cells, the selective deleting of characters representing the trial solution numerals from said at least some of the cells being performed by a user entering characters representing the initial and/or solution numerals into the user input.

21. An electronic device for use in solving Sudoku puzzles, the electronic device including a display including a 9×9 matrix of cells arranged in nine columns and nine rows, a data reading arrangement for entering characters representing only one of the initial numerals from one to nine into selected ones of the cells in response to a data bearing medium including instructions for the initial numerals of selected columns and rows being in the data reading arrangement, the data reading arrangement being arranged to read data from a memory medium selectively insertable into and removable from a receptacle of a housing carrying the electronic device, the memory medium being selectively insertable into and removable from the housing by a user of the electronic device.

22. The electronic device of claim 21 wherein the housing has a size, weight and shape enabling it to be carried by one hand of the user.
